(19) United States
(12) Patent Application Publication
(10) Pub. No.: US 2002/0109810 A1
(43) Pub. Date: Aug. 15, 2002

(54) Half reflection type liquid crystal display

(76) Inventor: Heng Chung Wu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/781,412

(22) Filed: Feb. 13, 2001

(51) Int. Cl. G02F 1/1335

(52) U.S. Cl. 349/113

(57) ABSTRACT

The present invention provides a half reflection type LCD comprising a liquid crystal panel. At least a compensation plate is arranged on the upper surface of the liquid crystal panel, and a polarizing plate is provided on the outer surface of the compensation plate. A holographic reflector is arranged on the lower surface of the liquid crystal panel. A backlight modular is arranged below the holographic reflector to be used as a light source. The present invention has a good light-collecting effect, a high brightness, and a low cost. Moreover, original fabrication process and equipments can still be used.

### FIELD OF THE INVENTION

The present invention relates to a liquid crystal display (LCD) and, more particularly, to a half reflection type LCD having also the effect of total reflection. The present invention can be extensively applied to super twisted nematic type LCDs and thin film transistor (TFT) LCDs.

### BACKGROUND OF THE INVENTION

Displays are the most direct sensory interfaces between humans and televisions and between humans and electronic/information products. The quality of a display directly influences the visual feel of the user or even the emotion of the user. Therefore, there are more and more efforts devoted to researches relevant to displays. The research points of emphasis focus on how to switch from monochromatic, low-resolution, bulky, highly power-dissipating, small area displays to color, high-resolution, compact, lowly power-dissipating, large area displays. Because LCDs have the characteristics of thin shape, light weight, low power dissipation, they have been widely used as large displays such as screens of desktop computers and small displays such as portable information terminals. The rate of usage of LCDs gradually increases.

FIG. 1 shows the most basic LCD in the prior art. An LCD comprises an upper glass substrate 10 and a lower glass substrate 12. A transparent conductive layer of indium tin oxide (ITO) 14, a liquid crystal layer 18, and a transparent conductive layer 16 are provided in turn between the facing surfaces of the two glass substrates 10 and 12. A retardation layer 20 and a polarizing plate 24 cover the outer surface of the upper glass substrate 10. A retardation layer 22 and a polarizing plate 26 cover the outer surface of the lower glass substrate 12. A reflecting plate 28 is provided outside the polarizing plate 26. Although the cost of an LCD of this type is lower, when an incident light is projected onto the LCD, because the incident light must first traverse the polarizing plates 24 and 26, be reflected by the reflecting plate 28, and then traverse the polarizing plates 26 and 24 the second time, part of the light will be much absorbed. Therefore, the quantity of light after reflection is much reduced so as to decrease the brightness. Moreover, because the reflecting plate 28 is placed outside of the lower polarizing plates 26, the problems of serious parallax and mélange may easily arise.

Accordingly, a half reflection type LCD has been developed. As shown in FIG. 2, an aluminum (Al) or silver alloy reflector 30 is directly coated on the lower glass substrate 12 and a backlight modular 32 that is arranged at the backlight position of the reflector 30. Because the metal reflector 30 won't let any light pass through, it has a plurality of latticed gaps thereon so that an incident light will be partly reflected and the backlight will be partly transmitted. This displaying way is the principle of a half reflection type LCD. Although this type of LCD resolves the above problems of serious parallax and mélange, the coating of the reflector 30 on the lower glass substrate 12 must be additionally performed so that the fabrication process will be changed, resulting in the problems of difficult process and high cost.

The present invention aims to propose an LCD having the advantages of LCD of the above two types so as to improve the above problems in the prior art.

### SUMMARY OF THE INVENTION

The primary object of the present invention is to provide a half reflection type LCD having a holographic reflector so as to have both the characteristics of reflection and back transmission. Moreover, the present invention has a good light-collecting effect so that sufficient brightness can be ensured near the normal viewing direction.

Another object of the present invention is to provide an LCD of high brightness and low cost, which can be produced using original fabrication process and equipments. Moreover, the problems of parallax and mélange can be more relieved.

According to the present invention, in a half reflection type LCD, at least a retardation layer and an upper polarizing plate are arranged on the upper surface of a liquid crystal panel, a holographic reflector, at least a retardation layer, and a lower polarizing plate are arranged in turn on the lower surface of the liquid crystal panel, and a backlight modular is arranged at the backlight position below the lower polarizing plate to be used as a backlight source.

The various objects and advantages of the present invention will be more readily understood from the following detailed description when read in conjunction with the appended drawings, in which:

### BRIEF DESCRIPTION OF THE DRAWINGS

FIG. 1 is a structure diagram of a prior art reflection type liquid crystal display;

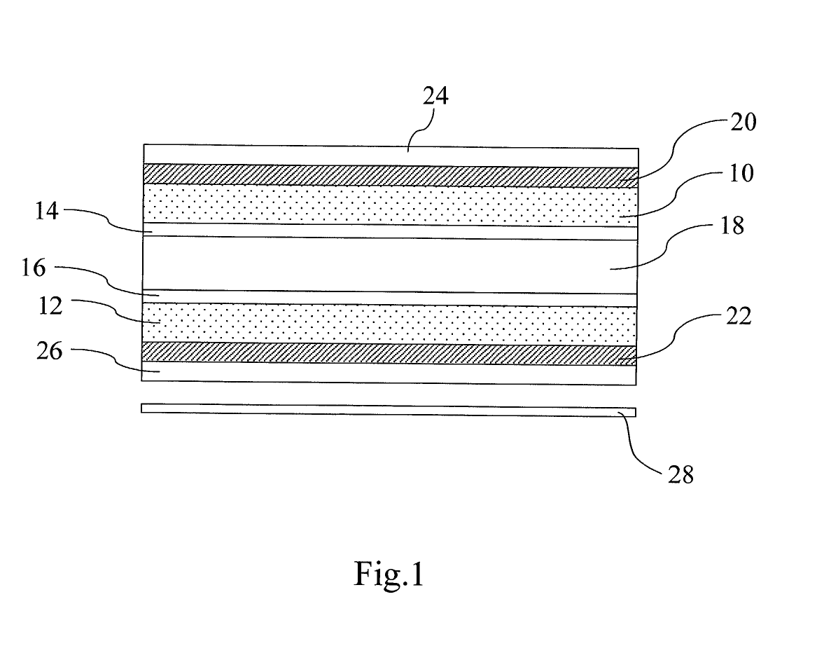

FIG. 2 is a structure diagram of a prior art half reflection type liquid crystal display;

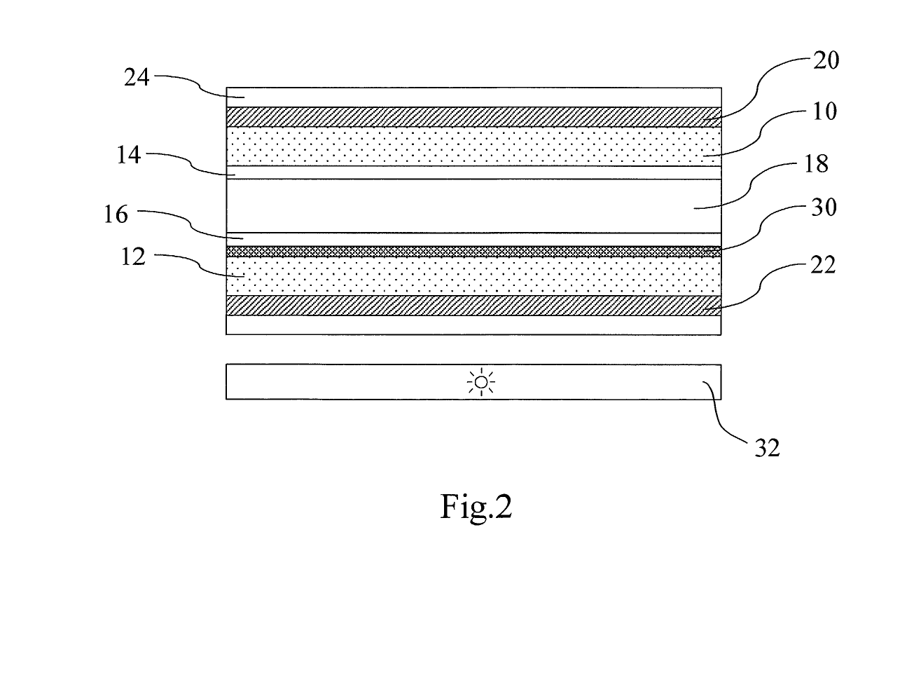

FIG. 3 is a structure diagram of the present invention; and

FIG. 4 is a structure diagram according to another embodiment of the present invention.

### DETAILED DESCRIPTION OF THE PREFERRED EMBODIMENTS

The present invention is characterized in that the effect of a holographic reflector in a half reflection type LCD is exploited to let the LCD have both the characteristics of reflection type and half reflection type LCD so that the drawbacks in the prior art can be effectively improved.

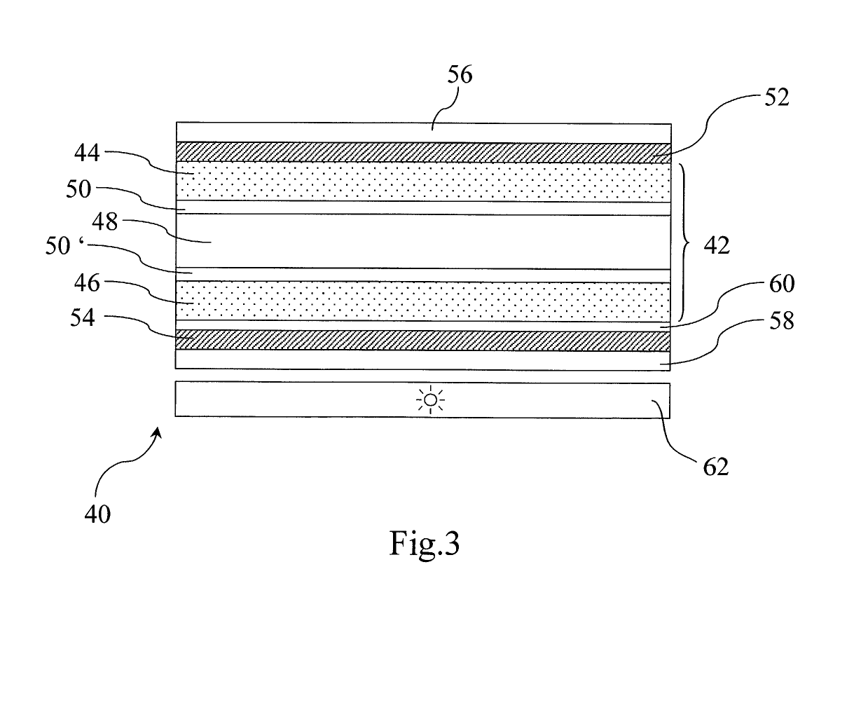

As shown in FIG. 3, a half reflection type LCD 40 comprises a liquid crystal panel 42, which comprises an upper transparent substrate 44 and a lower transparent substrate 46, a liquid crystal layer 48 between the facing surfaces of the two transparent substrates 44 and 46, and transparent conductive layers 50 and 50′ respectively covering the facing surfaces of the upper and lower transparent substrates 44 and 46. At least a retardation layer 52 and an upper polarizing plate 56 are provided in turn on the outer surface of the upper transparent substrate 44. A holographic reflector 60, at least a retardation layer 54, and a lower polarizing plate 58 are provided in turn on the outer surface of the lower transparent substrate 46 so that the holographic reflector 60 is situated between the lower transparent substrate 46 and the retardation layer 54. A backlight modular 62 is arranged at the backlight position below the lower polarizing plate 58 to be used as the required light source.

The upper transparent substrate 44 and the lower transparent substrate 46 of the liquid crystal panel 42 usually are substrates of transparent glass or other transparent materials. The two transparent substrates 44 and 46 are parallel spaced so that the transparent conductive layer 50, the liquid crystal layer 48, and the transparent conductive layer 50′ are situated between the facing surfaces thereof. The above holographic reflector can be replaced with a half reflector.

The above holographic reflector 60 has a very good light-collecting effect so that it has both the characteristics of reflection and back transmission. When the backlight modular 62 provides a backlight source, an incident light is also incident onto the half reflection type LCD 40. The above incident light will be reflected through the action of the holographic reflector 60, and the backlight emitted by the backlight modular 62 will be transmitted through the holographic reflector 60 simultaneously. Voltages for controlling brightness are applied to all liquid crystal pixels to form pictures. Contrarily, when the backlight modular 62 does not provide a backlight source, the holographic reflector 60 is only used as a reflecting plane to reflect all of the incident light.

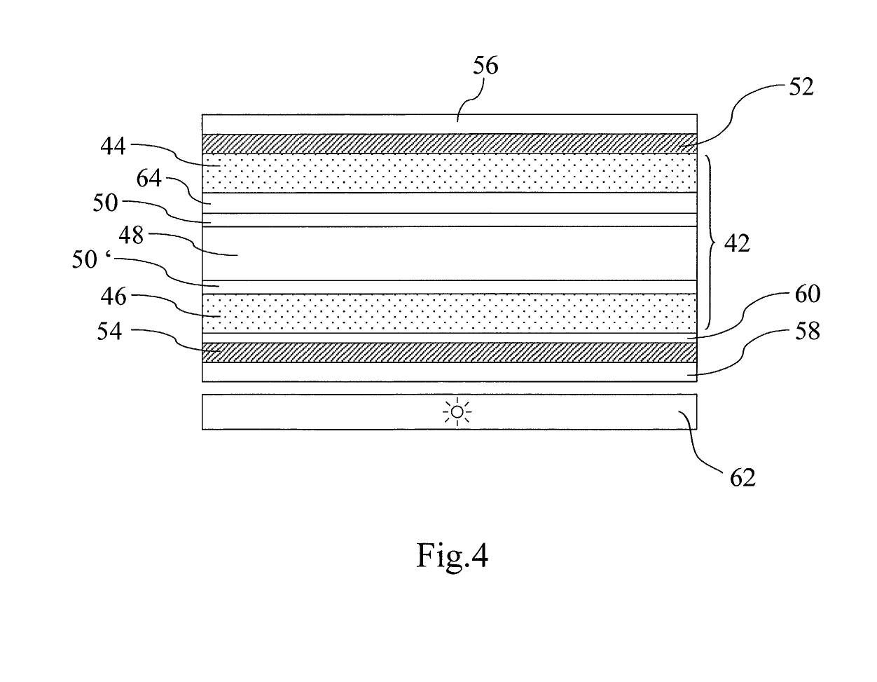

Additionally, the present invention can also adopt the structure of a color LCD. As shown in FIG. 4, a color filtering plate 64 is arranged between the upper transparent substrate 44 and the transparent conductive layer 50. Other structures are the same as above and thus will not be further described. The function of the color filter plate is to generate the three primary colors: red (R), green (G), and blue (B) by means of light filtering. The three primary colors are then mixed in different proportions to generate various kinds of colors when the LCD is driven by voltage so that the color LCD can display color pictures.

In addition to the above structures, the present invention can have other types. For instance, in the LCD shown in FIG. 3, only a lower polarizing plate can be provided to replace the retardation layer and the lower polarizing plate on the outer surface of the holographic reflector, and the retardation layer is not required. Or only the holographic reflector is reserved but the retardation layer and the lower polarizing plate are omitted. Effects identical to those of the present invention can be achieved. Moreover, a liquid crystal film can be used to replace the retardation layer as a compensation plate to achieve the same effects.

Because the holographic reflector is directly glued on the lower transparent substrate of the liquid crystal panel, the assembly technique is the same as that of the polarizing plate and the retardation layer. Therefore, original fabrication process and equipments can still be used so that the cost can be relatively reduced. Moreover, the LCD of the present invention has a good light-collecting effect through the characteristic of the holographic reflector so that sufficient brightness can be ensured near the normal viewing direction and the problems of parallax and melange can be more relieved.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A half reflection type liquid crystal display, comprising:
a liquid crystal panel comprising an upper transparent substrate and a lower transparent substrate parallel arranged, a transparent conductive layer, a liquid crystal layer, and a transparent conductive layer being provided in turn between said two transparent substrates;
at least a compensation plate arranged on the outer surface of said upper transparent substrate;
a polarizing plate arranged on the outer surface of said compensation plate;
a holographic reflector arranged on the outer surface of said lower transparent substrate; and
a backlight modular provided at the backlight position of said holographic reflector to provide a light source.

2. The half reflection type liquid crystal display as claimed in claim 1, wherein
a color filter plate is further provided between said upper transparent substrate and said upper transparent conductive layer.

3. The half reflection type liquid crystal display as claimed in claim 1, wherein
a color filter plate is further also provided between said lower transparent substrate and said lower transparent conductive layer.

4. The half reflection type liquid crystal display as claimed in claim 1, wherein
a holographic reflector is provided on the outer surface of said lower transparent substrate to be a reflection type liquid crystal display.

5. The half reflection type liquid crystal display as claimed in claim 1, wherein
said holographic reflector can be replaced with a half reflector.

6. The half reflection type liquid crystal display as claimed in claim 1, wherein
said holographic reflector can be replaced with a full reflector.

7. The half reflection type liquid crystal display as claimed in claim 1, wherein
a polarizing plate is further provided on the outer surface of said holographic reflector.

8. The half reflection type liquid crystal display as claimed in claim 1, wherein
a polarizing plate is further provided between said lower transparent substrate and said holographic reflector.

9. The half reflection type liquid crystal display as claimed in claim 1, wherein
at least a compensation plate and a polarizing plate are further arranged on the outer surface of said holographic reflector.

10. The half reflection type liquid crystal display as claimed in claim 1 or 9,
wherein said compensation plate can be a retardation layer or a liquid crystal film.

11. The half reflection type liquid crystal display as claimed in claim 1,
wherein said compensation plate can be omitted.
